(19) United States
(12) Patent Application Publication
(10) Pub. No.: US 2008/0040500 A1
(43) Pub. Date: Feb. 14, 2008

(54) Method and apparaatus for distributing a media stream

(75) Inventor: Guillaume Cohen, Palo Alto, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: VEODIA, INC., Palo Alto, CA (US)

(21) Appl. No.: 11/879,433

(22) Filed: Jul. 17, 2007

Related U.S. Application Data
(60) Provisional application No. 60/837,385, filed on Aug. 11, 2006.

(51) Int. Cl. G06F 15/16

(52) U.S. Cl. 709/231

(57) ABSTRACT

A method and apparatus for distributing a media stream using both unicast and multicast techniques. The method and apparatus comprising a server for distributing a media stream using a unicast transmission to a first receiver within a subnet network. The first receiver is from a plurality of receivers, operating as a primary repeater within the subnet network, using a multicast transmission of the media stream to at least one other receiver within the subnet network. The first receiver is replaced by another receiver from the plurality of receivers in the event that the first receiver fails.

### CROSS-REFERENCE TO RELATED APPLICATIONS

The present invention claims benefit of U.S. provisional patent application Ser. No. 60/837,385, filed on Aug. 11, 2006, which is herein incorporated by reference.

### BACKGROUND OF THE INVENTION

1. Field of the Invention

The present invention relates generally to distributing media data, and, more particularly, to a method and apparatus for distributing a media stream using both unicasting and multicasting.

2. Description of the Related Art

Electronic and computer advancements offer a vast selection of technologies for media signal encoding, distribution, and display. Examples of encoding devices include cameras, video recorders, media software on computers, mobile phone cameras and the like.

The encoded media signals (media data) can be made available over a network (e.g., Internet) to be viewed by a large number of viewing devices. However, multiple viewing devices sharing the same network to view media data, especially when sharing a slow bandwidth network, may affect the viewing quality of the media data. In addition, when a server is distributing media data using multiple streams, the server processing and resource utilization may be inefficient and negatively effected. To compensate for such an effect, lesser quality media may be distributed such that less bandwidth is consumed by the distributed stream, or additional servers and bandwidth may be purchased to accommodate the streams.

A stream is typically unicast from a server to a receiver using a point-to-point technique supported by the Internet Protocol (IP) unicast communications protocol. In other situations, a stream may be multicast from a server to a plurality of receivers using a point-to-multipoint technique supported by the IP multicast communications protocol. Multicasting is a very efficient mode of communications because a single copy of data is simultaneously available to many receivers. Any receiver that desires to receive the data simply registers with the network.

In some implementations, a unicast stream is received by a “repeater” that converts the unicast stream into a multicast stream for distribution on a specific network segment. In such an implementation, an interruption in the unicast transmission or the repeater operation leads to an interruption in the distribution of the data stream.

Therefore, there is a need for a method and apparatus that distributes media data in a robust manner.

### SUMMARY OF THE INVENTION

Embodiment of the present invention comprises a method and apparatus for distributing a media stream using both unicast and multicast techniques. The method and apparatus comprising a server for distributing a media stream using a unicast transmission to a first receiver within a subnet network. The first receiver is from a plurality of receivers, operating as a primary repeater within the subnet network, using a multicast transmission of the media stream to at least one other receiver within the subnet network. The first receiver is replaced by another receiver from the plurality of receivers in the event that the first receiver fails.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of one embodiment of a media distribution system that operates in accordance with the present invention;

FIG. 2 is a graphical representation of a portioned network;

FIG. 3 is a flow diagram of one embodiment of a method for distributing media in accordance with the present invention;

FIG. 4 depicts a flow diagram of a method of assigning a secondary repeater in accordance with one embodiment of the invention; and

FIG. 5 depicts a flow diagram of a method of selecting a new secondary repeater in accordance with one embodiment of the invention.

### DETAILED DESCRIPTION

The present invention comprises a media distribution technique that requires a single unicast media stream to be distributed to a first receiver on each multicast enabled subnet on which there are other receivers capable of receiving the media. The first receiver on each subnet receiving the unicast stream (i.e, a primary repeater) then redistributes the media stream via multicast to its entire subnet. Embodiments of the invention also handle disconnection of a primary repeater without interrupting the media stream being sent to other receivers on the multicast subnet.

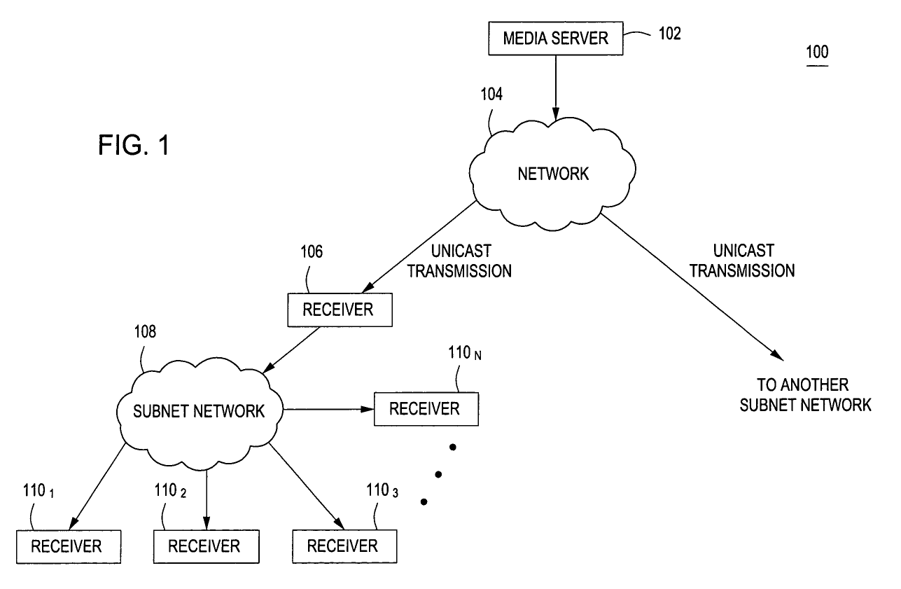

FIG. 1 depicts a block diagram of an embodiment of the present invention that is implemented as media distribution system 100. The system 100 comprises a media server 102, a network 104, a first receiver 106 (also referred to herein as the primary repeater), a subnet network 108, and a plurality of second receivers 110₁, 110₂, 110₃ and 110_{N}, where N is an integer value (collectively referred to as receivers 110). The server 102 transmits a unicast transmission to the first receiver 106. Generally, the receivers 106 and 110 are “peers”, i.e., substantially similar media players, where one of the peers receives the unicast transmission. The media received by the receiver 106 is re-distributed using a multicast technique to all receivers 110 that are part of the subnet network 108. In this manner, the server 102 distributed media streams to subnet networks and the receivers within the subnet networks distribute the media stream amongst themselves.

The system 100 implements a method for distributing media streams efficiently over networks that are composed of multicast and non-multicast subnets, leveraging the multicast nature of the network where it is available and automatically adapting to the topology of the network. This method is particularly suited for enterprise networks that have multiple Local Area Networks (LANs) that are multicast capable. As such, it is possible to send only one unicast stream per multicast subnet (instead of one individual stream per receiver), relying on one receiver per multicast subnet to re-multicast the stream for its peers. As shall be described below, the method is robust against disconnections from repeaters, ensuring continuity in the viewer experience.

The system 100 provides several benefits:
It improves the quality of service, making it possible for a large number of receivers 110 on a corporate network 108 to receive a live stream from the Internet (network 104), even if they are all sharing a relatively low bandwidth connection to the Internet.
It relieves the server 102 from having to serve multiple streams, taking advantage of the multicast nature of some sections of the network 104/108. Only one stream per multicast subnet 108 needs to be served, therefore dividing the bandwidth costs by the average number of receivers 110 per subnet.
It doesn't require any configuration: it automatically adapts to the topology of the network 104/108 removing the need to distribute content delivery network appliances and configure them.
It allows a server 102 to simultaneously serve users on a private network 108 and on the Internet (network 104) in an efficient way

Suppose A is the set composed of receivers of a video stream. Suppose ˜ represents the equivalence relation by which x˜y [symbol] if x receives a multicast stream, y can receive it as well. A/˜ is the quotient set of X by ˜ and realizes a partition. The equivalence class of a, [a]={x ε X|x˜a} constitutes the multicast subnet.

For any “audience A”, let A be the set A={a¹, . . . ,an} where each element is a receiver on a single IP network (computer, cell phone, set top box, and the like.) A is defined as “the network”. A can be described as the union of the largest disjoint subsets Ai made of elements sharing the same multicast networks.

A=∪Ai/∀i≠j, Ai∩Aj={ø} so that

∩{x, y} ε Ai, x and y are on the same multicast network

∩{x, y} ε Ai\textcircled{X}Aj with i≠j, x and y are not on the same multicast network

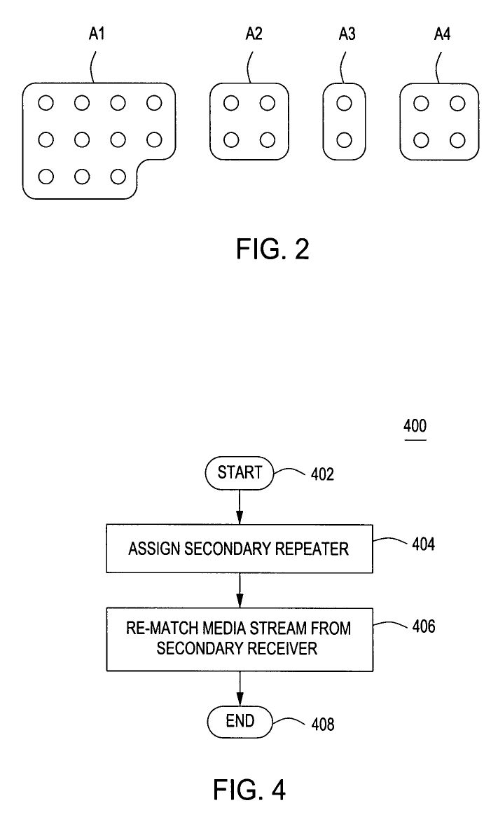

Example of partition of a network A with 21 receivers is shown in FIG. 2. In each sub network Ai, the elements are receivers on a single multicast network. The network can be reduced to four multicast subsets A1, A2, A3 and A4.

For any partition, N is the number of multicast subsets in the partition. The following describes the limit cases.

For an audience where receivers are each on a unique multicast subset, each multicast subset is reduced to a singleton and the number of multicast subsets equals the number of receivers. This limit case corresponds to the centralized server approach where a server unicasts directly to each receiver. On a purely multicast network, all the elements (receivers) are on a same multicast network serviced by a server and N=1. The technique used by the invention is a generalization of both the full multicast case and the full unicast case.

The bandwidth savings that results from use of the invention using combined unicast and multicast transmissions can be quantified as:

$$\begin{matrix}Savings ( \% ) = ( Number of Receivers - Number of Subnets ) / \\ ( Number of Receivers ) \\ = 1 - ( 1 / Average Number of Receivers per subnet )\end{matrix}$$

The system 100 combines the notions of peer-to-peer distribution (at the application layer) and multicast (at the network layer).

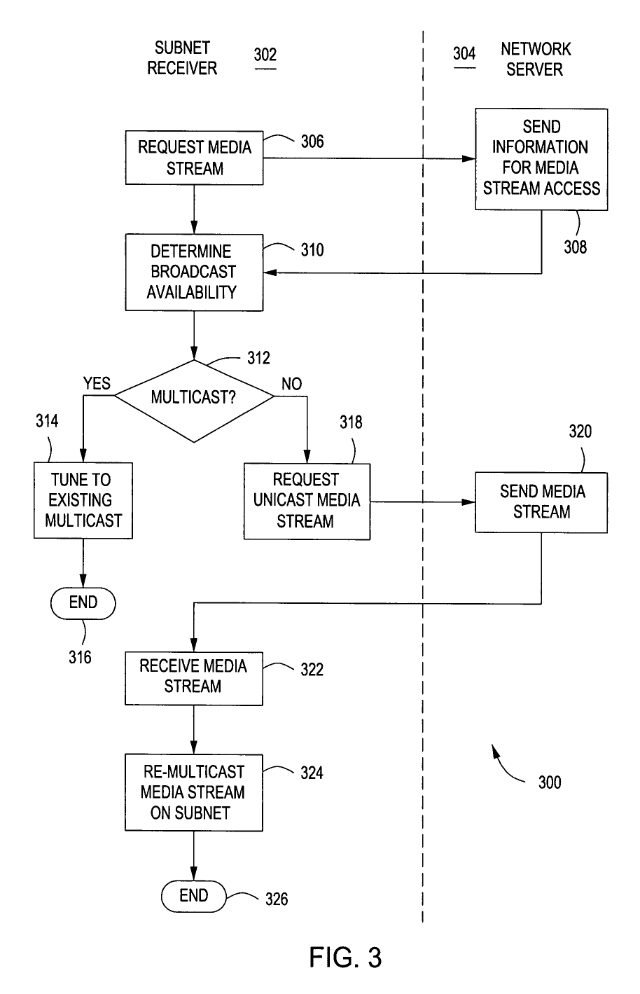

FIG. 3 depicts a flow diagram of a method 300 of operation for the system 100. The method 300 is divided into operation of the subnet receiver (portion 302) and operation of the network server (portion 304). At step 306, a receiver sends a request to the server for a media stream. At step 308, the server responds with the necessary information to access the Internet Protocol (IP) broadcast of the live stream. Then, at step 310, the receiver determines if there is already a broadcast which is accessible by the receiver, i.e., another receiver is presently multicasting the stream. If a multicast session is found at step 312, the viewer simply tunes in to the existing multicast at step 314 and the method ends at step 316. If no multicast session is found at step 312, the receiver requests a unicast stream from the central server at step 318. At step 320, the server sends the requested stream and, at step 327, the receiver starts receiving the stream. At step 324, the receiver starts re-multicasting the stream on its subnet, using the broadcast information provided by the server. The re-multicasting process involves the repeater opening both an IP unicast socket and at least one IP multicast socket, then reading a packet from the IP unicast socket and writing the pocket the at least one IP multicast socket. This procedure is repeated for all the packets in a stream. In this case, the receiver becomes the representative of his multicast subnet or viewer class. The method 300 ends at step 326.

The system is also robust against viewing device (receiver) disconnections. When the representative of a class disconnects from the stream (the repeater decides to stop watching, or the computer that is the receiver crashes); it is then necessary to find another relay in the same class without affecting the experience of other receivers in the same class.

Several alternative methods for determining a new repeater are possible. In one embodiment of the invention, a secondary repeater may be used for each multicast subnet. FIG. 4 depicts a flow diagram of a method 400 of selecting a secondary repeater. The method 400 begins at step 402 and proceeds to step 404 where the server assigns a secondary repeater within the subnet. In this embodiment, at step 406 the secondary repeater always sends a redundant instance of the multicast stream. This second instance can either be on the same multicast channel or on a different channel (multicast IP+ port). All receivers in the subnet will receive packet duplicates that will be discarded. The method 400 ends at step 408.

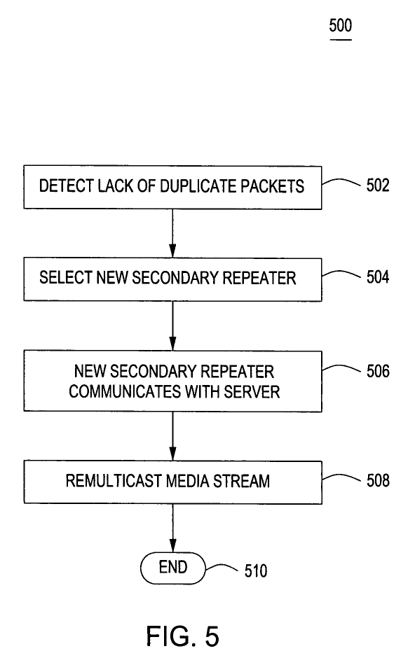

FIG. 5 depicts a flow diagram of a method 500 for detecting the disconnection of a repeater and selecting a new secondary repeater. At any time, each receiver can determine whether there are still two concurrent repeaters on their multicast subnet by determining that it is receiving multicast packets from two different resources by examining the origin IP of the multicast packets. When one of the two repeaters disconnects, each receiver can determine that it is no longer receiving duplicate packets. The method 500 is initiated at step 502 upon detection of a disconnected repeater via the lack of duplicate packets. At that point, a new secondary repeater must initiate a connection with the streaming server and begin re-multicasting for its peers. At step 504, the method 500 selects a new secondary repeater. Various selection processes may be used as discussed below. Once a new secondary repeater is selected, at step 506, the new secondary repeater communicates with the server to identify itself and its status as the secondary repeater. At step 508, the server sends a unicast transmission to the secondary repeater and the repeater remulticasts the media stream to the receivers in the subnet. The method 500 ends at step 510.

At least two methods can be used to determine the new secondary repeater. In one embodiment, the new secondary repeater is designated by the video server. When receivers determine that a new secondary repeater is needed, each requests the server to determine which receiver should be designated as the new secondary repeater from the available receivers. The server then designates the new secondary repeater. The server maintains a log of all viewing devices that request a stream and may determine the new secondary repeater based on an arbitrary rule. For example, one possible rule could state that the last receiver to join the network shall become the first potential secondary repeater.

Alternatively, other considerations could be taken into account such as statistical data about receivers, their measured disconnection rate or other information. Another possibility could be for the server to designate the first receiver to inquire with the server on who should be the new secondary repeater.

Another method for selecting a new secondary repeater involves receivers collaborating among themselves to agree on which receiver device is going to become the new repeater. For example, each receiver on a multicast subnet may maintain a potential repeater table which contains a ranked list of the current receivers on their multicast subnet. When a new receiver joins a multicast subnet it sends a multicast announcement to notify other receivers that it has joined the multicast subnet and will be the new first potential secondary repeater if a current repeater disconnects. The receivers on the multicast subnet will receive this message and update their potential repeater tables by ranking the new viewing device highest in their table. The new first potential secondary repeater continues to send an update message periodically to inform the other receivers that it is still connected to the multicast subnet. When the current secondary repeater disconnects, the other receivers check their potential repeater tables to determine which receiver on their multicast subnet is the current first potential secondary repeater. At that point, the designated receiver needs only to initiate a connection with the central server to receive a new unicast stream. If the first potential secondary repeater disconnects, other receivers on the network will cease to receive periodic updates from that receiver and will update their potential repeater tables by deleting the disconnected receiver. The new potential candidate is then the receiver that connected prior to the disconnected receiver. This receiver will now begin broadcasting periodic updates, being at the top of his own list.

While the reconnection process takes time, the media streams to other receivers on the multicast subnet will not be interrupted because they are still receiving packets from the primary repeater on the multicast subnet.

This method can be extended to an arbitrary number of secondary repeaters as a means of increasing redundancy and reliability. For instance, a third redundant repeater can also be selected to receive a stream from the streaming unit and to relay its received packets as a multicast transmission. In this way any number between 2 and N (the number of total viewers in the multicast cloud) repeaters can be used.

Under an alternative or supplemental method for recovering from repeater disconnections, each receiver maintains a buffer of incoming packets received as a multicast from the repeater. If the repeater disconnects, each receiver detects the disconnection because they stop receiving multicast packets. Upon detecting a repeater disconnection, each receiver sends a query to a central server. The central server then designates a new repeater upon receiving a notification that the original repeater had disconnected. The server's response to each receiver query is either a notification that the current receiver is designated as a new repeater, or a packet containing the address of the new repeater. One possible method of designating a new repeater is to assign the first receiver that reports a repeater disconnect as a new repeater. The newly designated repeater then establishes a new streaming connection with the streaming unit which had originally been streaming to the old repeater.

In the time between the time the original repeater disconnected (time A) and the time the new repeater starts receiving and relaying packets as a multicast (time B), the live broadcast is still going, so some packets will not reach this multicast cloud during this time. In the time between A and B, each individual receiver can avoid interrupting the playback by playing packets received before time A from its local buffer. When the new repeater begins relaying packets after time B, the receivers can begin buffering packets again. However, because of the missed packets during the disconnected time, there will be an empty region in each receivers' buffer representing these missed packets that should have been sent between time A and time B. A method for recovering these missing packets is as follows: When the new repeater requests an rtsp connection from the streaming unit, it also reports the index of the last successfully received packet before the original repeater disconnected. In response, the streaming unit will send a second, temporary stream to the new repeater, which begins with the first missed packet. Since the streaming unit is recording the live streams, it will be possible to serve subsections of the live streams starting at any arbitrary index number in the past. The second stream will provide the new repeater with the packets which were missed between time A and B. The new repeater will relay these replacement packets to the multicast receivers as a second multicast in addition to the multicast of the live packets. Once the receivers receive the replacement packets, they will place them in the appropriate position in their local buffers. In this way the playback can continue uninterrupted even if a repeater disconnects occurs.

Note that if the buffer size is insufficient to maintain viewer playback between time A and B, a playback interruption will occur. Therefore, the buffer size must be set adequately large to cover the time between interruption and new buffer connection.

Both of the previously discussed techniques (Multiple redundant repeaters, Viewer buffering with repeater disconnection recovery) can be used simultaneously. There are disadvantages with using these methods individually. The redundancy method, if using a high number of simultaneous repeaters, will create additional redundant network traffic within the multicast cloud as well as requiring additional redundant streams from the streaming unit, increasing, bandwidth and server requirements. The buffering method, if using a large buffer size, can significantly increase the latency of the broadcast. It is possible to use both methods together as a way of balancing and mitigating these factors.

Multiple repeaters can be designated at the start of a broadcast. These repeaters simultaneously relay their received streams as redundant multicasts. The receivers will then buffer the received multicast packets, disregarding duplicate packets due to redundancy. The receivers detect when any of the multiple repeaters disconnects by checking if a multicast stops being received from a given IP address. Upon detection of a disconnection, a new repeater can be chosen as described earlier. Unless all the multiple repeaters disconnect simultaneously, the method described in the buffering section of filling in the gap in the receiving buffers will not be necessary, since the live broadcast will be maintained by the remaining repeaters, and no break in the reception of live packets will occur. If all the repeaters disconnect, then new repeaters can be designated as described in the buffering section, and the resulting gap in the receiver buffers can be filled in by the use of temporary streams from the streaming unit to the newly designated repeaters.

The decision about how many redundant repeaters and the receiver buffer size can be selected based on a tradeoff between bandwidth and latency considerations. Increased number of repeaters increases bandwidth requirements while reducing the probability of simultaneous disconnection, which reduces the estimated buffer size required and thus the receiver latency. Using a larger buffer size increases receiver latency, but reduces the number of redundant servers required and thus the required bandwidth, since simultaneous disconnections would be recoverable with a sufficiently large buffer.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus for distributing a media stream comprising:
a server for distributing a media stream using a unicast transmission to a first receiver within a subnet network; and
the first receiver is from a plurality of receivers, operating as a primary repeater within the subnet network, using a multicast transmission of the media stream to at least one other receiver within the subnet network, wherein the first receiver is replaced by another receiver from the plurality of receivers in the event that the first receiver fails.

2. The apparatus of claim 1, wherein the replacement of the first receiver is based on an algorithm.

3. The apparatus of claim 1, wherein where any one of the at least one other receiver is utilized as a secondary repeater.

4. The apparatus of claim 1, further comprising the secondary repeater using a multicast transmission of the media stream to at least one other receiver within the subnet network, where the media stream is transmitted on the subnet network using redundant packets.

5. The apparatus of claim 1, wherein the unicast transmission is propagated through a public network.

6. The apparatus of claim 1, wherein the public network is the Internet.

7. The apparatus of claim 1, wherein the first receiver and the other receivers are substantially similar to enable any two of the first receiver and the other receivers to respectively operate as primary and secondary repeaters.

8. A method of distributing a media stream comprising:
receiving a media stream via a unicast transmission through a network at a receiver that is operating as a primary repeater; and
redundantly retransmitting the received media stream via a multicast transmission to receivers on a subnet network.

9. The method of claim 8, wherein the receiving steps comprise requesting the media stream from a server;
receiving information regarding media stream access;
determining media stream availability using the information;
if the media stream is available, tune to existing media stream; and
if the media stream is unavailable, request the server to send a unicast transmission of the media stream.

10. The method of claim 9, wherein the server maintains a record of receivers receiving the media stream.11. The method of claim 8, wherein the redundantly retransmitting step comprises:
assigning a secondary repeater to receive the media stream; and
re-transmitting the received media stream to the at least one other receiver on the subnet network to form a redundant media stream.

12. The method of claim 11, wherein the secondary repeater is assigned based on at least one of a record of receivers, statistical records about the receivers, a first receiver to receive the media stream, an agreement between the receivers or an arbitrary rule.

13. The method of claim 11 further comprising:
detecting a lack of duplicate packets from at least one of the primary repeater and secondary repeater;
selecting a new secondary repeater;
communicating with the server to have a unicast transmission of the media stream sent to the new secondary repeater; and
re-transmitting the received media stream from the new secondary repeater to the receivers on the subnet network.

14. The method of claim 8 further comprising at least one of:
receiving at least one notification of a new receiver within the subnet network;
updating a potential secondary repeater record; and
ranking receivers to determine a potential secondary repeater.

15. The method of claim 14, wherein the potential secondary repeater sends connection updates to inform the receivers within the subnet network that the potential secondary repeater is connected to the subnet network.
